(19) United States
(12) Patent Application Publication
(10) Pub. No.: US 2025/0167198 A1
(43) Pub. Date: May 22, 2025

(54) METHOD OF MEASURING CHANGE RATE OF CLOSED PORE, METHOD AND SYSTEM FOR MANUFACTURING ELECTRODE PLATE, AND ELECTRODE PLATE

(71) Applicant: SAMSUNG SDI CO., LTD., Yongin-si, Gyeonggi-do (KR)

(72) Inventors: Hang In CHO, Suwon-si (KR); Jong Min WON, Suwon-si (KR); So Jeong YU, Suwon-si (KR); Jae Hou NAH, Suwon-si (KR); Joong Ho MOON, Suwon-si (KR); Se Young OH, Suwon-si (KR); Yu Rim CHA, Suwon-si (KR)

(21) Appl. No.: 18/646,612

(22) Filed: Apr. 25, 2024

(30) Foreign Application Priority Data
Nov. 16, 2023 (KR) 10-2023-0159231

(51) Int. Cl. H01M 4/04; G01B 7/32; H01M 4/139

(52) U.S. Cl. CPC H01M 4/0435; G01B 7/32; H01M 4/139

(57) ABSTRACT

In a method of measuring a closed-pore change rate, the method includes: measuring, by small-angle X-ray scattering (SAXS) and Brunauer, Emmett, and Teller (BET), a specific surface area in a first powder state and a specific surface area in a second powder state with respect to pores created in a powder state; measuring, by SAXS and BET, a specific surface area in a first electrode plate state and a specific surface area in a second electrode plate state with respect to pores created in an electrode plate state; and calculating a closed-pore change rate of an electrode plate based on the specific surface areas in the first and second powder states and the specific surface areas in the first and second electrode plate states.

### CROSS-REFERENCE TO RELATED APPLICATION

The present application claims priority to and the benefit of Korean Patent Application No. 10-2023-0159231, filed on Nov. 16, 2023, in the Korean Intellectual Property Office, the entire disclosure of which is incorporated herein by reference.

### BACKGROUND

### 1. Field

Aspects of some embodiments of the present invention relate to a method of measuring a closed-pore change rate, an electrode manufacturing method, an electrode manufacturing system, and an electrode plate.

### 2. Description of the Related Art

In recent years, consumer demand for relatively high energy density and relatively high-capacity secondary batteries has grown rapidly with the rapid spread and adoption of electronic devices using batteries, such as mobile phones, notebook computers, and electric vehicles. Thus, various research and development has been actively carried out to improve lithium secondary batteries.

A lithium secondary battery generally includes a cathode, an anode, an electrolyte, and a separator interposed between the cathode and the anode that contain active materials allowing intercalation and deintercalation of lithium ions, and produces electrical energy through oxidation and reduction upon intercalation/deintercalation of lithium ions in the cathode and the anode.

At least one of the cathode, the anode, the electrolyte, or the separator or at least part therebetween may include pores. The pores include open pores and closed pores. The open pores refer to pores connected to the outside. The closed pores refer to pores isolated from the outside.

The pores affect electrode density, porosity and/or mobility of the secondary battery. Accordingly, the pores affect material properties and/or electrochemical properties of the secondary battery. However, a method of efficiently measuring porosity is not established in the art.

For example, methods of measuring porosity include a BET measurement method, a mercury pore analysis method, and the like. However, these methods can analyze open pores and are not suitable for measurement of closed pores.

The above information disclosed in this Background section is only for enhancement of understanding of the background and therefore the information discussed in this Background section does not necessarily constitute prior art.

### SUMMARY

Aspects of some embodiments of the present invention include a method of measuring a closed-pore change rate in a certain material.

For example, aspects of some embodiments include a method of measuring a closed-pore change rate of an electrode plate.

Aspects of some embodiments of the present invention include a method of setting a suitable rolling pressure for an electrode plate and/or a method of manufacturing an electrode plate based on the closed-pore change rate.

Aspects of some embodiments of the present invention include an electrode plate manufactured by rolling such that a closed-pore change rate between a powder state and an electrode plate state is in a predetermined range.

Aspects of some embodiments of the present invention include an electrode plate manufactured by rolling such that a closed-pore change rate before and after rolling is in a predetermined range.

The above and other aspects and features of embodiments according to the present invention will become more apparent from the following description of embodiments of the present invention.

According to some embodiments of the present invention, in a method of measuring a closed-pore change rate, the method includes: measuring, by small-angle X-ray scattering (SAXS) and Brunauer, Emmett, and Teller (BET), a specific surface area in a first powder state and a specific surface area in a second powder state with respect to pores created in a powder state; measuring, by SAXS and BET, a specific surface area in a first electrode plate state and a specific surface area in a second electrode plate state with respect to pores created in an electrode plate state; and calculating a closed-pore change rate of an electrode plate based on the specific surface areas in the first and second powder states and the specific surface areas in the first and second electrode plate states.

According to some embodiments of the present invention, an electrode manufacturing method includes: measuring, by small-angle X-ray scattering (SAXS) and Brunauer, Emmett, and Teller (BET), a specific surface area in a first powder state and a specific surface area in a second powder state with respect to pores created in a powder state; measuring, by SAXS and BET, a specific surface area in a first electrode plate state and a specific surface area in a second electrode plate state with respect to pores created in an electrode plate state; calculating a closed-pore change rate of an electrode plate based on the specific surface areas in the first and second powder states and the specific surface areas in the first and second electrode plate states; setting a degree of rolling for the electrode plate based on the closed-pore change rate of the electrode plate; and manufacturing the electrode plate by rolling the electrode plate according to the degree of rolling.

According to some embodiments of the present invention, an electrode manufacturing system includes: a measurement unit measuring specific surface areas in a powder state and in an electrode plate state through SAXS (Small-Angle X-ray Scattering) and BET (Brunauer, Emmett, Teller); and a processor calculating a closed-pore change rate of an electrode plate based on specific surface areas in first and second powder states and specific surface areas in first and second electrode plate states measured by the measurement unit, and setting a degree of rolling for the electrode plate based on the closed-pore change rate of the electrode plate.

According to some embodiments of the present invention, an electrode plate includes: an anode material; and a substrate coated with the anode material, wherein the anode material has a closed pore change rate of 200% or less before and after rolling.

According to some embodiments, the method of measuring a closed-pore change rate includes measuring a closed-pore change rate present in any material.

For example, the method of measuring the closed-pore change rate according to some embodiments may measure the closed-pore change rate present in an electrode plate between a powder state and an electrode plate state.

The electrode manufacturing method and/or the electrode manufacturing system according to some embodiments may manufacture an electrode plate based on the closed-pore change rate.

For example, the electrode manufacturing method and/or the electrode manufacturing system according to some embodiments may include manufacturing an electrode plate by rolling under a suitable pressure based on the closed-pore change rate.

For example, the electrode plate according to some embodiments may be produced by suitable rolling.

However, aspects and characteristics of embodiments according to the present invention are not limited to those described above and other aspects and characteristics not mentioned will be more clearly understood by those skilled in the art from the detailed description given below.

### BRIEF DESCRIPTION OF THE DRAWINGS

The following drawings attached to this specification illustrate aspects of some embodiments of the present invention, and further describe aspects and features of some embodiments of the present invention together with the detailed description of some embodiments of the present invention. Thus, embodiments according to the present invention should not be construed as being limited to the drawings:

FIG. 1 to FIG. 4 are schematic cross-sectional views of lithium secondary batteries according to some embodiments of the present invention;

FIG. 5A and FIG. 5B are a schematic view of an electrode plate according to some embodiments of the present invention;

FIG. 6 is a schematic view of pores in an electrode plate according to some embodiments of the present invention;

FIG. 7A to FIG. 7C are a schematic diagram illustrating a method of measuring closed pores in an electrode plate according to some embodiments of the present invention;

FIG. 8 is a block diagram of an electrode manufacturing system according to some embodiments of the present invention;

FIG. 9 is a flowchart illustrating a method of measuring a closed-pore change rate according to some embodiments of the present invention;

FIGS. 10A-10C are graphs and views illustrating an effect of the degree of rolling on an electrode plate;

FIGS. 11A-11C are graphs depicting a relationship between rolling and porosity.

FIG. 12 is a flowchart illustrating an electrode manufacturing method according to some embodiments of the present invention;

FIG. 13A to FIG. 13C are a graph depicting a relationship between the degree of rolling and performance of an electrode plate; and

FIG. 14A to FIG. 14C is a schematic view of an electrode plate according to some embodiments before and after rolling.

### DETAILED DESCRIPTION

Hereinafter, aspects of some embodiments of the present invention will be described, in more detail, with reference to the accompanying drawings. The terms or words used in this specification and claims should not be construed as being limited to the usual or dictionary meaning and should be interpreted as having meanings and concepts consistent with the technical idea of the present invention based on the principle that the inventor can be his/her own lexicographer to appropriately define the concept of the term to explain his/her invention in the best way. The embodiments described in this specification and the configurations shown in the drawings are only some of the embodiments of the invention and do not represent all of the technical ideas, aspects, and features of the invention. Accordingly, it should be understood that there may be various equivalents and modifications that can replace or modify the embodiments described herein at the time of filing this application. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof. Further, the use of “may” when describing embodiments of the invention relates to “one or more embodiments of the invention.”

In the figures, dimensions of the various elements, layers, etc. may be exaggerated for clarity of illustration. The same reference numerals designate the same elements.

References to two compared elements, features, etc. as being “the same,” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless specified otherwise, each element may be singular or plural.

When an arbitrary element is referred to as being disposed (or located or positioned) “above” (or “below”) or “on” (or “under”) a component, it may mean that the arbitrary element is placed in contact with the upper (or lower) surface of the component and may also mean that another component may be interposed between the component and any arbitrary element disposed (or located or positioned) on (or under) the component.

In addition, it will be understood that, when an element is referred to as being “coupled,” “linked” or “connected” to another element, the elements may be directly “coupled,” “linked” or “connected” to each other, or an intervening element may be present therebetween, through which the element may be “coupled,” “linked” or “connected” to another element. In addition, when a part is referred to as being “electrically coupled” to another part, the part can be directly connected to another part or an intervening part may be present therebetween such that the part and another part are indirectly connected to each other.

Throughout the specification, when “A and/or B” is stated, it means A, B or A and B, unless specified otherwise. That is, “and/or” includes any or all combinations of a plurality of items enumerated. When “C to D” is stated, it means C or more and D or less, unless specified otherwise.

The terminology used herein is for the purpose of describing aspects of some embodiments of the present invention and is not intended to be limiting of embodiments according to the present invention.

### Lithium Secondary Battery

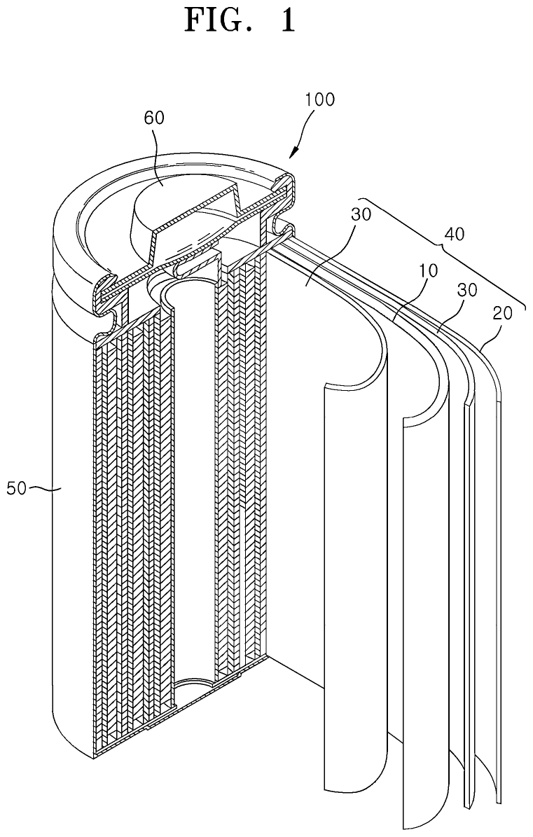

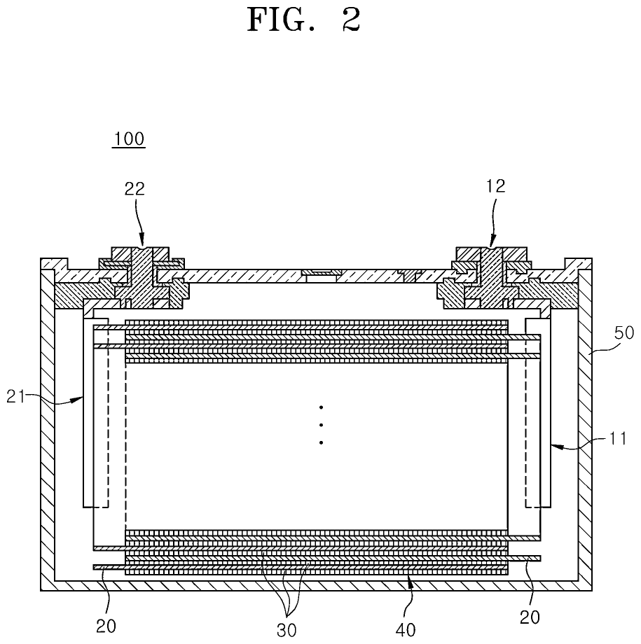

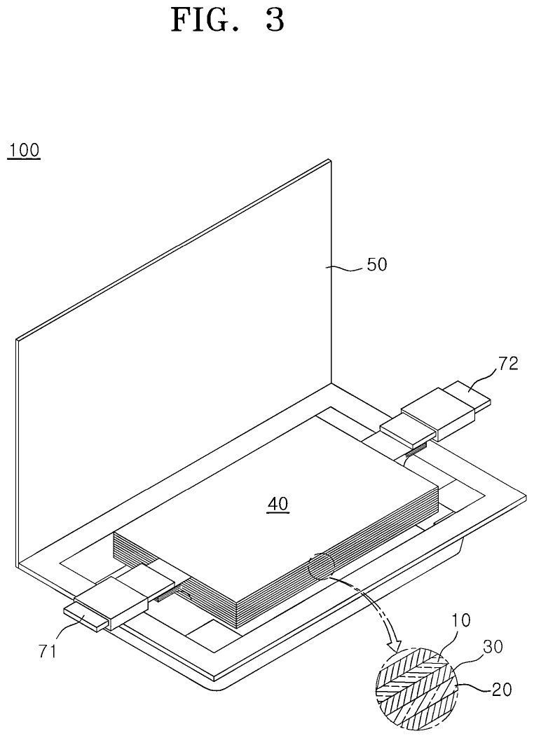

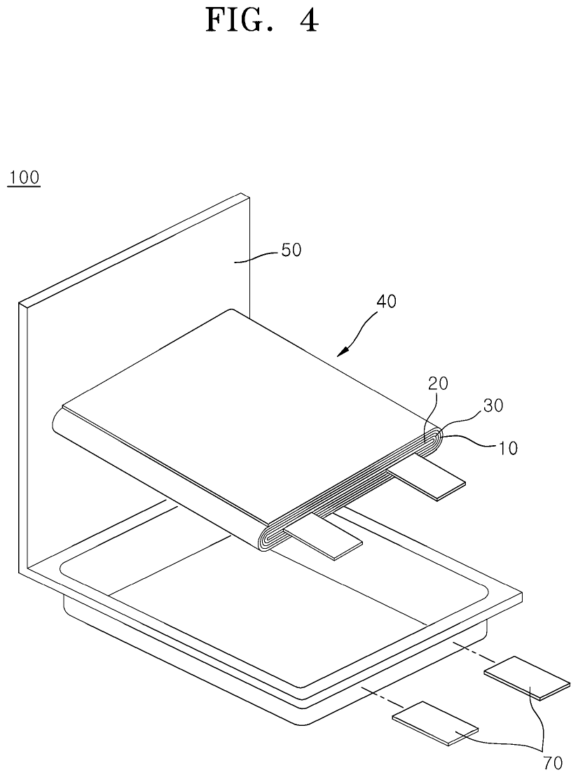

Lithium secondary batteries may be classified into a cylindrical secondary battery, a faceted secondary battery, a pouch type secondary battery, a coin type secondary battery, and the like based on the shapes thereof. FIG. 1 to FIG. 4 are schematic views of lithium secondary batteries according to some embodiments of the present invention, in which FIG. 1 shows a cylindrical secondary battery, FIG. 2 shows a faceted secondary battery, and FIG. 3 and FIG. 4 show pouch-type secondary batteries. Referring to FIG. 1 to FIG. 4, a lithium secondary battery 100 may include an electrode assembly 40 in which a separator 30 is interposed between a cathode 10 and an anode 20, and a case 50 that receives the electrode assembly 40 therein. The cathode 10, the anode 20, and the separator 30 may be embedded in an electrolyte. The lithium secondary battery 100 may include a sealing member 60 that seals the case 50, as shown in FIG. 1. In addition, as shown in FIG. 2, the lithium secondary battery 100 may include a cathode lead tab 11, a cathode terminal 12, an anode lead tab 21, and an anode terminal 22. As shown in FIG. 3 and FIG. 4, the lithium secondary battery 100 may include electrode tabs 70, that is, a cathode tab 71 and an anode tab 72, which act as electrical pathways conducting current formed in the electrode assembly 40 to the outside.

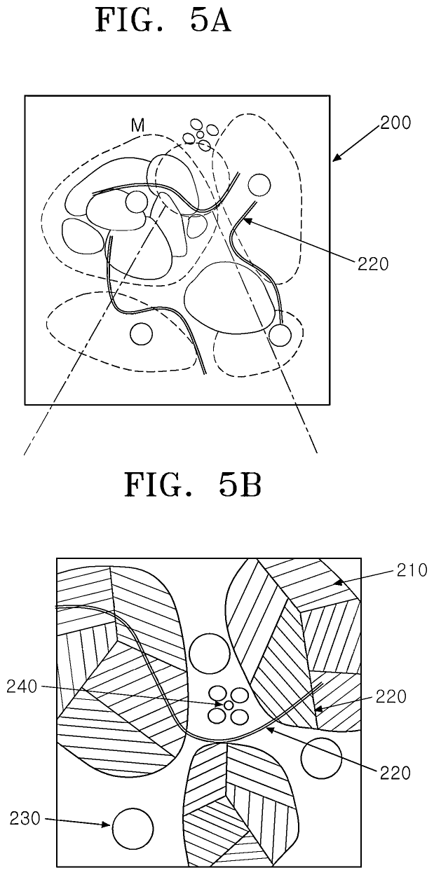

With reference to FIG. 1 to FIG. 4, schematic components and/or materials of the lithium secondary battery are described. Hereinafter, referring to FIG. 5 to FIG. 14, a method of manufacturing the lithium secondary battery 100 illustrated in FIG. 1 to FIG. 4 or methods used for manufacture of the secondary battery will be described in more detail.

For example, a method of rolling an electrode plate for a secondary battery with suitable rolling strength and an electrode plate manufactured by the method will be described below. In addition, a method for setting suitable rolling strength will be described below. For example, a method of measuring a change rate of pores between a powder state and an electrode plate state for setting suitable rolling strength will be described below. Specifically, the method of measuring the change rate of pores between the powder state and the electrode plate state includes 1) measuring a change rate of open pores between the powder state and the electrode plate state, 2) measuring a change rate of the pores between the powder state and the electrode plate state, and 3) measuring a closed-pore change rate between the powder state and the electrode plate state based thereon.

FIG. 5A and FIG. 5B are a schematic view of an electrode plate according to some embodiments of the present invention.

In FIG. 5A, reference numeral 200 denotes the electrode plate according to some embodiments. FIG. 5B is an enlarged view of a region M shown in FIG. 5A.

Referring to FIG. 1 to FIG. 4, a secondary battery (including, for example, the lithium secondary battery 100 illustrated in FIG. 1 to FIG. 4) includes an electrode plate 200 (including, for example, the cathode 10 or the anode 20 illustrated in FIG. 1 to FIG. 4). The electrode plate includes, for example, a cathode plate and an anode plate. The electrode plate 200 is formed by coating an active material on a current collector. As a result, the electrode plate 200 allows electrochemical reaction to occur and allows electrons to enter and exit from the active material upon charging/discharging of the secondary battery.

For example, as shown in FIG. 5B, the electrode plate 200 includes, for example, graphite 210, a binder 220 (for example, CMC, SBR and the like), and a coating material 230 (for example, carbon black, super P black, and the like). In FIG. 5B, although the electrode plate 200 is illustrated as an anode plate by way of example, it should be understood that this is provided for illustration only and the electrode plate 200 according to some embodiments includes a cathode plate. The electrode plate 200 may further include lithium ions 240 absorbed from the cathode plate. The electrode plate 200 includes pores in a slurry coated onto a substrate.

The electrode plate 200 coated with the active material is subjected to a rolling process. As a result, the thickness of the electrode plate 200 is reduced. In addition, the electrode plate 200 has an increased energy density and is organized, thereby allowing ions to move more easily through the electrode plate. Here, the pores formed in the electrode plate 200 may be changed in shape or disappear during the rolling process. In addition, new pores may be created in the electrode plate 200 after the rolling process (or any process for manufacture of the electrode or the secondary battery).

The degree of change of the pores correlates with electrochemical performance of the secondary battery. Accordingly, determination as to the degree of change of the pores and change in characteristics of the pores are essential for improvement in electrochemical performance. Accordingly, the following description will focus on a method of determining the degree of change of the pores.

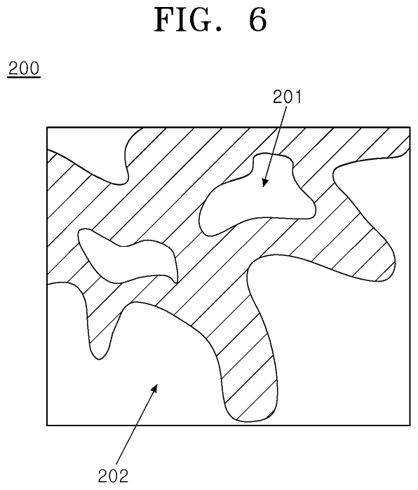

FIG. 6 is a schematic view of pores included in an electrode plate according to some embodiments.

As illustrated in FIG. 5A and FIG. 5B, the electrode plate 200 includes pores 201, 202. The pores 201, 202 include, for example, closed pores 201 and open pores 202. The closed pores 201 are pores generated in the electrode plate and isolated from the outside. The open pores 202 are pores generated in the electrode plate and at least partially connected to the outside.

Although FIG. 5A, FIG. 5B and FIG. 6 illustrate an example in which the electrode plate 200 includes the pores 201, 202, pores to be measured by the measurement method according to some embodiments are not limited to the pores 201, 202 present in the electrode plate 200. The pores include any pores contained in a certain material or generated between any two or more certain materials. For example, the pores may be formed inside the electrode plate 200, a separator (for example, the separator 30 illustrated in FIG. 1 to FIG. 4), an electrolyte (for example, the electrolyte illustrated in FIG. 1 to FIG. 4), or between two or more thereof. For convenience of description, the following description will focus on the case where the pores 201, 202 are included in the electrode plate 200 by way of example.

As illustrated in FIG. 5, the pores 201, 202 affect the electrochemical properties of the secondary battery. For example, the pores 201, 202 affect electrode density, porosity and/or mobility of the secondary battery. This is because creation, disappearance, or change of the pores 201, 202 causes change in surface area of the electrode plate 200 (or electrodes including the electrode plate 200).

Accordingly, in some embodiments, the degree of change of the pores 201, 202 through change in surface area of the electrode plate 200 is determined. To quantify the change in surface area, the term “specific surface area” will be used herein. The specific surface area refers to a surface area per mass. In the following, a method of determining the degree of change of pores based on the specific surface area will be described.

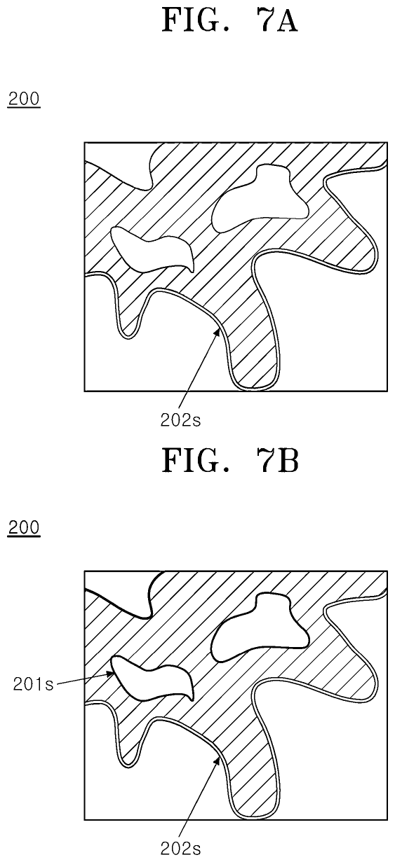

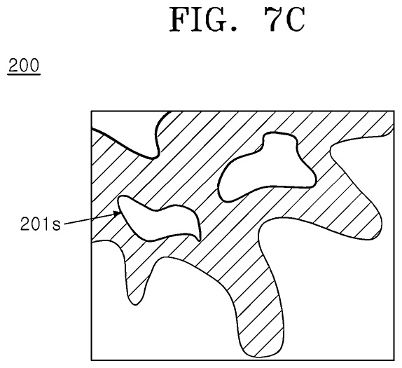

FIG. 7A to FIG. 7C are a schematic diagram illustrating a method of measuring closed pores in an electrode plate according to some embodiments of the present invention.

FIG. 7A shows the specific surface area of open pores. FIG. 7B shows the specific surface area of pores.

The electrode plate 200 includes the closed pores 201 and the open pores 202. The closed pores 201 include a specific surface area 201s of the closed pores. The open pores 202 include a specific surface area 202s of the open pores. The specific surface area of the pores including at least one of the closed pores 201 or the open pores 202 is measured by a first measurement method. The first measurement method includes, for example, Small-Angle X-ray Scattering (SAXS).

The electrode plate 200 includes the open pores 202. The open pores 202 include a specific surface area 202s of the open pores. The specific surface area 202s of the open pores is measured by a second measurement method. The second measurement method includes, for example, a Brunauer-Emmett-Teller (BET) method, a mercury porosity method, and the like. Hereinafter, by way of example, the BET method will be described as the second measurement method for convenience of description.

FIG. 7C shows the specific surface area of the closed pores. A measurement method that directly measures only the specific surface area of the closed pores has not yet been found. Accordingly, in a method of measuring a closed-pore change rate according to some embodiments, the change rate of the closed pores 201 is measured based on the specific surface areas of the pores 201, 202 and the specific surface area of the open pores 202.

For example, in the method of measuring the closed-pore change rate, the degree of change (or change rate) of the specific surface area of the closed pores 201 before and after rolling of the electrode plate 200 is calculated by subtracting the amount of change in specific surface area of the open pores 202 before and after rolling of the electrode plate 200 (measured and calculated, for example, as in FIG. 7A) from the amount of change in specific surface area of the pores 201, 202 before and after rolling of the electrode plate 200 (measured and calculated, for example, as in FIG. 7B).

In this way, the method of measuring the closed-pore change rate according to some embodiments may calculate the change rate of the closed pores 201. Next, a system and method for measuring the change rate of the closed pores 201 and/or a method for manufacturing an electrode plate will be described in more detail.

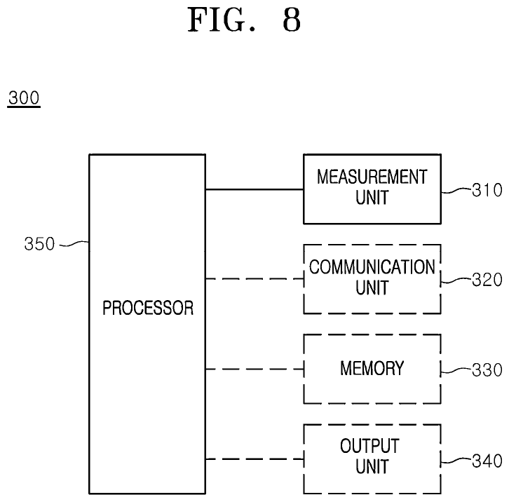

FIG. 8 is a block diagram of an electrode manufacturing system according to some embodiments of the present invention

In FIG. 8, reference numeral 300 denotes the electrode manufacturing system according to some embodiments. The electrode manufacturing system 300 calculates the change rate of the closed pores illustrated in FIG. 5A to FIG. 7C and manufactures the electrode plate 200 based on the closed-pore change rate.

To this end, the electrode manufacturing system 300 includes a measurement unit 310 and a processor 350. The electrode manufacturing system 300 may further include, for example, a communication unit 320, a memory 330, or an output unit 340. However, the electrode manufacturing system 300 is not limited to the components shown in FIG. 8 and may include all or only some of the components shown in FIG. 8. Further, the electrode manufacturing system 300 may include additional components not shown in FIG. 8. For example, the electrode manufacturing system 300 may further include input units (e.g., keyboard, mouse, sensor, etc.) to receive commands from a user.

With such configuration, the electrode manufacturing system 300 according to some embodiments may calculate a suitable rolling pressure based on the change rate of the closed pores and may manufacture the electrode plate 200 based on the calculated rolling pressure. Detailed description of each component is as follows by way of example.

The measurement unit 310 measures the specific surface area of the electrode plate 200. To this end, the measurement unit 310 includes a sensor or device capable of measuring the specific surface area of the electrode plate 200.

For example, the measurement unit 310 measures the specific surface area of the electrode plate 200 in a powder state. The specific surface area of the electrode plate 200 in the powder state includes specific surface area characteristics of pores of the electrode plate 200 in the powder state. For example, the measurement unit 310 measures a specific surface area of the electrode plate 200 in a first powder state through the first measurement method. The first measurement method includes, for example, an SAXS method. In addition, for example, the measurement unit 310 measures a specific surface area of the electrode plate 200 in a second powder state through the second measurement method. The second measurement method includes, for example, a BET method. Here, the specific surface area of the electrode plate 200 in the powder state may be, for example, the specific surface area of the electrode plate 200 before rolling.

In addition, for example, the measurement unit 310 measures a specific surface area of the electrode plate 200 in an electrode plate state. The specific surface area of the electrode plate 200 in the electrode plate state includes specific surface area characteristics of pores in the electrode plate 200 in the electrode plate state. For example, the measurement unit 310 measures a specific surface area of the electrode plate 200 in a first electrode plate state through the first measurement method. The first measurement method includes, for example, the SAXS method. In addition, for example, the measurement unit 310 measures a specific surface area of the electrode plate 200 in a second electrode plate state through the second measurement method. The second measurement method includes, for example, the BET method. Here, the specific surface area of the electrode plate 200 in the electrode plate state may be, for example, the specific surface area of the electrode plate 200 after rolling.

The communication unit 320 enables the electrode manufacturing system 300 to communicate with external servers, devices, and the like, through wired, wireless, short-range or long-range communication. For example, the communication unit 320 transmits measured data to an external server or receives necessary data therefrom through the measurement unit 310.

The memory 330 stores instructions for operation of the electrode manufacturing system 300. The instructions include, for example, data about the method of measuring a closed-pore change rate, a method of calculating the degree of rolling for an electrode plate based on the closed-pore change rate, and the like. The memory 330 may be, for example, a volatile memory or a non-volatile memory. The memory 330 may include, for example, CPU, cache, DRAM, Persistent memory, flash SSD, HDD, CD/DVD, Cloud server, and the like.

The output unit 340 outputs alarms generated from the electrode manufacturing system 300. The alarms include, for example, data measured by the measurement unit 310, the state of at least one of the components included in the electrode manufacturing system 300, and the like. The output unit 340 includes, for example, a display outputting visual alarms, a speaker outputting audible alarms, and a haptic module outputting tactile alarms. However, it should be understood that the output unit 340 is not limited thereto and includes any form of output unit 340 capable of outputting an alarm.

The processor 350 controls all or some of the components included in the electrode manufacturing system 300. The processor 350 calculates the closed-pore change rate of the electrode plate 200 based on data measured by the measurement unit 310. For example, the processor 350 calculates the closed-pore change rate of the electrode plate 200 based on the specific surface areas of the electrode plate 200 in the first and second powder states and the specific surface areas of the electrode plate 200 in the first and second electrode plate states. The processor 350 sets a rolling degree of the electrode plate 200 based on the closed-pore change rate of the electrode plate 200.

The processor 350 may be embedded in the electrode manufacturing system 300. Alternatively, the processor 350 may be placed outside the electrode manufacturing system 300 and may control the respective components included in the electrode manufacturing system 300 through wired or wireless communication.

The processor 350 may include, for example, a central processing unit (CPU), a microprocessor unit (MPU), a microcontroller unit (MCU), a graphics processing unit (GPU), a digital signal processor (DSP), a floating-point unit (FPU), an application specific integrated circuit (ASIC), field programmable gate array (FPGA), and the like.

As such, the electrode manufacturing system 300 according to some embodiments may parameterize the specific surface area characteristics of the electrode plate 200 measured by two or more measurement methods through cross-analysis of the specific surface area characteristics thereof before and after rolling to determine the closed-pore change rate of the electrode plate 200 based on the measured parameters. In addition, the electrode manufacturing system 300 according to some embodiments may set a suitable rolling pressure for the electrode plate 200 based on the closed-pore change rate.

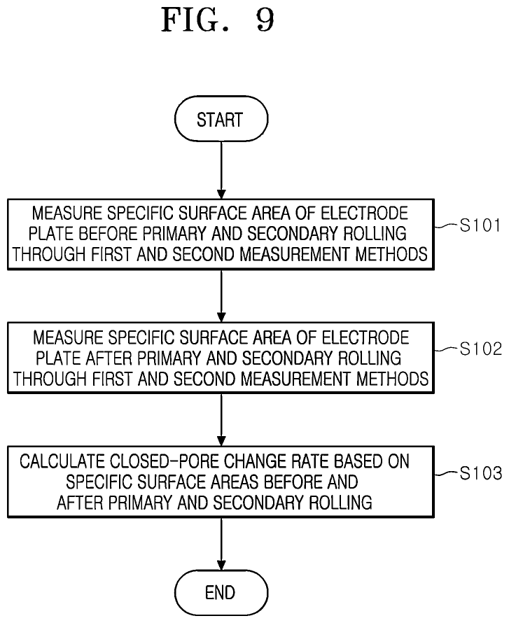

FIG. 9 is a flowchart illustrating a method of measuring a closed-pore change rate according to some embodiments of the present invention.

Referring to FIG. 9, the method of measuring the closed-pore change rate in the electrode plate 200 illustrated in FIG. 5 to FIG. 8 will be described in detail.

On the other hand, the measurement method illustrated in FIG. 9 may be performed not only by the electrode manufacturing system 300 according to the embodiments illustrated with respect to FIG. 8, but also by any system including separate devices capable of performing corresponding operations, or by other devices capable of performing corresponding operations. In other words, an entity capable of implementing the method of measuring the closed-pore change rate according to the embodiments illustrated with respect to FIG. 9 is not limited to the electrode manufacturing system 300 according to some embodiments. However, in FIG. 9 and the following description, the method of measuring the closed-pore change rate according to some embodiments performed by the electrode manufacturing system 300 will be described by way of example for convenience of description.

Referring to FIG. 9, the method of measuring the closed-pore change rate according to some embodiments includes the operation of measuring the specific surface areas of the electrode plate 200 in first and second powder states through the first and second measurement methods (S101).

The powder state includes all states of the anode material layer in all stages before the active material layer is prepared into a slurry. For example, the powder state includes the anode material in powder form. Alternatively, for example, the powder state includes a mixture of the anode material in powder form with additives. The additives include, for example, a coating material, a binder, and the like.

The measurement unit 310 measures the specific surface area of the electrode plate in the powder state through the first measurement method and/or the second measurement method. The measurement unit 310 measures the specific surface area of the electrode plate in the first powder state and/or the specific surface area of the electrode plate in the second powder state. Description as to how the measurement unit 310 measures the specific surface area of the electrode plate in the first powder state and/or the specific surface area of the electrode plate in the second powder state is the same as or similar to the description of the measurement unit 310 illustrated in FIG. 8.

Referring to FIG. 9, the method of measuring the closed-pore change rate according to some embodiments includes the operation of measuring the specific surface area of the electrode plate 200 in the first and second electrode plate states through the first and second measurement method (S102).

The electrode plate state includes all states of the electrode plate, in which the active material layer of the electrode plate 200 is not in the powder state. For example, the electrode plate state includes a state of the electrode plate, in which the active material layer is prepared into a slurry and coated onto a substrate. Here, the electrode plate state includes the state of the electrode plate before rolling or with the slurry coated onto the substrate. Alternatively, the electrode plate state includes all states of the electrode plate 200 in all stages where, for example, the thickness of the electrode plate 200 is reduced and/or the electrode density of the electrode plate 200 is increased after rolling. For example, the state of the electrode plate includes a sheet state (including states of a sheet, web, film, and the like) after rolling. In this case, the electrode plate state is a state of the electrode plate, in which the electrode plate has a long length and can be wound or unwound, rather than a state of an individual electrode. For example, the electrode plate state is a state of the electrode plate, in which notching is performed on the electrode plate in sheet form. In this case, the electrode plate state is a sheet state that includes tabs. For example, the electrode plate state is a state of the electrode plate, in which the electrode plate is divided into individual electrodes by slitting. For example, the electrode plate state is a state of the electrode plate, in which the electrode plate is mounted on the secondary battery, for example, an electrode state.

The measurement unit 310 measures the specific surface area of the electrode plate in the electrode plate state through the first measurement method and/or the second measurement method. The measurement unit 310 measures the specific surface area of the electrode plate in the first electrode plate state and/or the specific surface area of the electrode plate in the second electrode plate state. Description of the measurement unit 310 measuring the specific surface area of the electrode plate in the first electrode plate state and/or the specific surface area of the electrode plate in the second electrode plate state are the same as or similar to the description of the measurement unit 310 illustrated with respect to FIG. 8.

Referring to FIG. 9, the method of measuring the closed-pore change rate according to some embodiments includes the operation of calculating the change rate of the closed pores 202 based on the specific surface areas thereof before and after primary and secondary rolling (S103).

Based on operations S102 and S103, the processor 350 calculates the change rate of the specific surface area of the closed pores 202 in the electrode plate 200 before and after rolling. For example, the processor 350 calculates a difference in change rate of the closed pores when the electrode plate is subjected to the same process, for example, rolling, through cross analysis of pore measurement methods of two or more mechanisms. Specifically, the processor 350 calculates, for example, the change rate of the specific surface area of the closed pores 202 of the electrode plate 200 before and after rolling according to Equation 1:

$$Closed - pore change rate ( \% ) = ( A - B ) \times 100 , \qquad ( 1 )$$

where “closed-pore change rate” indicates a change rate of the specific surface area of the closed pores 202 in the electrode plate 200 before and after rolling.

Here, A denotes a change amount of the pores 201, 202 between the powder state of the electrode plate 200 and the electrode plate state thereof. Specifically, A denotes the amount of change in specific surface area of pores (including the open pores 201 and/or the closed pores 202) in the electrode plate 200 in the course of rolling the electrode plate 200. In some embodiments, since the amount of change in specific surface area of the closed pores 201 is measured based on trend of change in specific surface area of the electrode plate between the powder state and the electrode plate state, A denotes the amount of change in specific surface area of the pores 201, 202 between the powder state and the electrode plate state and/or the amount of change in specific surface area of the pores 201, 202 between the powder state and the electrode plate state. The processor 350 calculates the amount of change A of the pores in the electrode plate 200 between the powder state and the electrode plate state, for example, according to Equation 2:

$$A = \frac{EA - PA}{PA} , \qquad ( 2 )$$

Here, EA denotes the specific surface area of the electrode plate in the first electrode plate state, as measured through the first measurement method. Specifically, EA denotes the specific surface area of the electrode plate in the electrode plate state, as measured through the first measurement method. For example, EA denotes the specific surface area of the electrode plate (or the pores in the electrode plate) in the electrode plate state, as measured through the first measurement method. Alternatively, for example, EA denotes the specific surface area of the electrode plate as measured through the first measurement method, in which the electrode plate may have the active material layer coated in a slurry state on the substrate and is not subjected to rolling.

In addition, PA denotes the specific surface area of the electrode plate in the first powder state, as measured through the first measurement method. Specifically, PA denotes the specific surface area of the active material layer coated onto the substrate in the powder state before the active material layer is in the slurry state, as measured through the first measurement method. For example, PA denotes the specific surface area of the electrode plate (or the pores in the electrode plate) in the powder state, as measured through the first measurement method.

Returning to the description of Equation 1, B denotes the change amount of the open pores 202 in the electrode plate 200 between the powder state and the electrode plate state. For example, B denotes the amount of change in specific surface area of the open pores 201 in the electrode plate 200 in the course of rolling the electrode plate 200. In some embodiments, since the degree of change in specific surface area of the closed pores 201 is measured based on trend of change in specific surface area of the electrode plate between the powder state and the electrode plate state, like A, B denotes the amount of change in specific surface area of the electrode plate between the powder state and the electrode plate state and/or the amount of change in the specific surface area of the open pores 202 between the powder state and the electrode plate state. The processor 350 calculates the amount of change B in the open pores of the electrode plate 200 between the powder state and the electrode plate state, for example, according to Equation 3:

$$B = \frac{EB - PB}{PB} , \qquad ( 3 )$$

Here, EB denotes the specific surface area of the electrode plate in the second electrode plate state, as measured through the second measurement method. Specifically, EB denotes the specific surface area of the electrode plate in the electrode plate state, as measured through the second measurement method. For example, EB denotes the specific surface area of the electrode plate (or the open pores in the electrode plate) in the electrode plate state, as measured through the second measurement method. Alternatively, for example, EB denotes the specific surface area of the electrode plate, as measured through the second measurement method, in which the electrode plate may have the active material layer coated in a slurry state onto the substrate and is not subjected to rolling.

In addition, PB denotes the specific surface area of the electrode plate in the second powder state, as measured through the second measurement method. Specifically, PB denotes the specific surface area of the active material layer coated onto the substrate in the powder state before the active material layer is in the slurry state, as measured through the second measurement method. For example, PB denotes the specific surface area of the electrode plate (or the open pores in the electrode plate) in the powder state, as measured through the second measurement method.

In this way, the method of measuring the closed-pore change rate according to some embodiments can provide a method of measuring the degree of change of the closed pores (tendency).

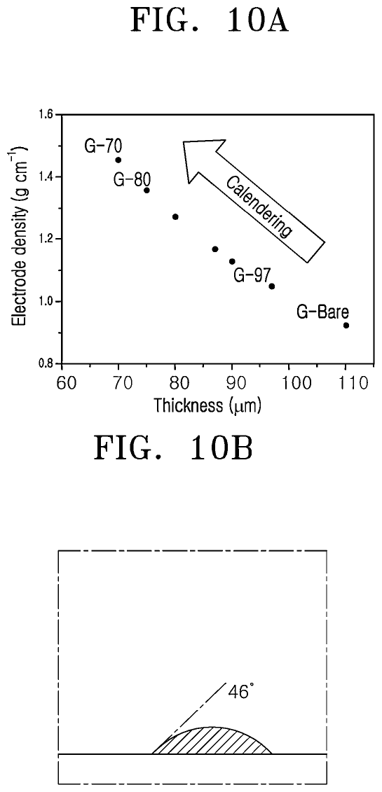

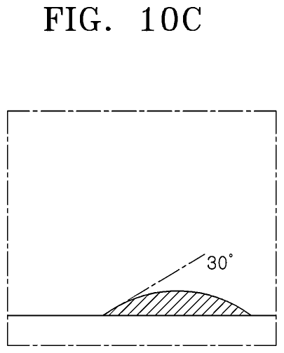

FIG. 10A to FIG. 10C are a graph and views illustrating an effect of the degree of rolling on an electrode plate.

FIG. 10A to FIG. 10C illustrate performance of the electrode plate 200 according to the degree of rolling with respect to the electrode plate 200 to illustrate a relationship between the closed-pore change rate and the process of manufacturing the electrode plate 200.

FIG. 10A shows electrode density of the electrode plate 200 according to the degree of rolling with respect to the electrode plate 200.

In FIG. 10A, the abscissa represents the thickness (μm) of the electrode plate 200 according to rolling. For example, G-Bare denotes the electrode plate 200 not subjected to rolling. For example, G-97 denotes an electrode plate having a thickness of 97 μm after rolling, G-80 denotes an electrode plate having a thickness of 80 μm after rolling, and G-70 denotes an electrode plate having a thickness of 70 μm after rolling. Here, a smaller thickness indicates a greater degree of rolling (e.g., rolling pressure) on the electrode plate 200.

In FIG. 10A, the ordinate represents the electrode density (g·cm³).

As can be seen in FIG. 10A, a greater degree of rolling on the electrode plate 200 results in a higher electrode density.

FIG. 10B shows the degree of electrolyte impregnation when the electrode plate 200 has a thickness of 70 μm after rolling. FIG. 10C shows the degree of electrolyte impregnation when the electrode plate 200 has a thickness of 80 μm after rolling.

The electrode plate 200 (thickness: 70 μm) shown in FIG. 10C was subjected to a lower degree of rolling than the electrode plate 200 (thickness: 80 μm) shown in FIG. 10B. FIG. 10B and FIG. 10C show the angle of the electrolyte when a time (e.g., a set or predetermined time) had elapsed after dropping the electrolyte onto the electrode plate subjected to rolling.

According to some embodiments, G-Bare shown in FIG. 10A was impregnated so quickly that the impregnation angle could not be measured. For the electrode plate shown in FIG. 10B, the angle of the electrolyte was 46 degrees. For the electrode plate shown in of FIG. 10C, the angle of the electrolyte was 30 degrees.

From this result, it can be seen that impregnability decreases with increasing degree of rolling. Specifically, as the degree of rolling increases, an interior space of the electrode plate 200 is reduced. For example, as the degree of rolling increases, the space between active materials in the active material layer of the electrode plate 200 is reduced. Accordingly, impregnability of the electrolyte decreases with increasing degree of rolling.

Furthermore, although rolling is an essential process in manufacture of secondary batteries, excessive rolling provides excessive stress to the materials thereof, causing deterioration in stability of the secondary batteries and/or conductivity of ions/electrons. As a result, for example, the secondary batteries can suffer from damage to the active material or deterioration in cell performance.

Accordingly, it is necessary to determine an optimal degree of rolling with respect to the electrode plate 200.

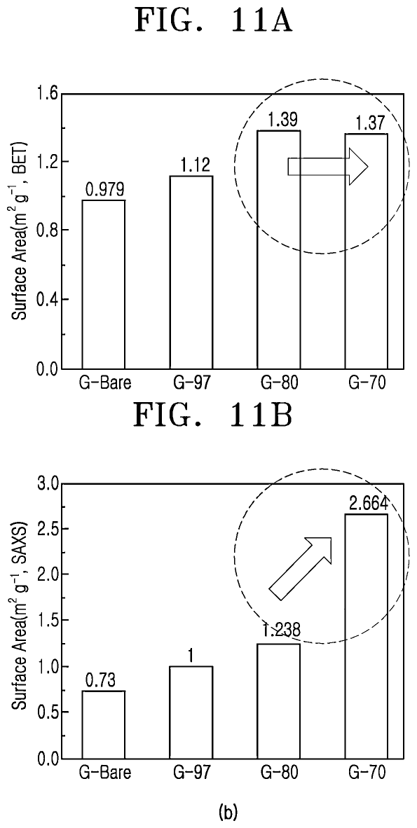

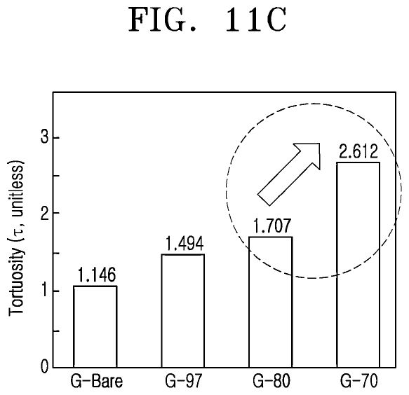

FIG. 11A to FIG. 11C are a graph depicting a relationship between rolling and porosity.

It can be seen from FIG. 10A to FIG. 10C that the optimal degree of rolling is desirable for various performance aspects of the electrode plate 200. On the other hand, FIG. 11A to FIG. 11C show the relationship between the change rate of pores and the degree of rolling.

FIG. 11A is a graph depicting change in specific surface area of the electrode plate 200 measured by the second measurement method depending on the degree of rolling. FIG. 11B is a graph depicting change in specific surface area of the electrode plate 200 measured by the first measurement method depending on the degree of rolling.

It can be seen from FIG. 11A and FIG. 11B that the specific surface area increases with increasing degree of rolling. FIG. 11A and FIG. 11B show that the electrode plates have different tendencies in specific features. For example, referring to FIG. 11A, when the change in the specific surface area of the open pores 202 in the electrode plate 200 was measured through the second measurement method, the specific surface area of the open pores 202 in the electrode plate 200 subjected to rolling to have a thickness of 80 μm was substantially similar to the specific surface area of the open pores 202 in the electrode plate 200 subjected to rolling to have a thickness of 70 μm. However, referring to FIG. 11B, when the change in the specific surface area of the pores 201, 202 in the electrode plate 200 is measured by the first measurement method, there is a large difference between the specific surface area of the electrode plate 200 subjected to rolling to have a thickness of 80 μm and the specific surface area of the electrode plate 200 subjected to rolling to have a thickness of 70 μm.

FIG. 11A and FIG. 11C are a graph depicting change in tortuosity of the electrode plate 200 depending on the degree of rolling. A smaller tortuosity value indicates more effective movement of lithium ions within the electrode plate 200.

Referring to FIG. 11C, the difference between tortuosity of the electrode plate 200 subjected to rolling to have a thickness of 80 μm and tortuosity of the electrode plate 200 subjected to rolling to have a thickness of 70 μm is large. In other words, it can be seen that the relationship between the degree of rolling and tortuosity shown in FIG. 11C is relatively similar to the relationship between the degree of rolling measured in FIG. 11B and the specific surface area of the pores 201, 202 in the electrode plate 200, as measured through the first measurement method. Accordingly, it can be seen that it is difficult to interpret electrochemical results of the electrode plate 200 based only on the specific surface area of the electrode plate 200, as measured through the second measurement method.

However, most prior studies have interpreted the electrochemical results of the electrode plate 200 using the second measurement method. In order to compensate for such inaccuracies, there is a need to interpret the electrochemical results of the electrode plate 200 using information about the closed pores implied by the first measurement method.

Accordingly, in the method of measuring the closed-pore change rate, the electrode manufacturing method, and/or the electrode manufacturing system according to the embodiments, the closed-pore change rate is measured and used to provide better understanding of the electrochemical results of the electrode plate 200, for example, porosity of the electrode plate 200.

Further, in some embodiments, the optimal degree of rolling is found from the closed-pore change rate based on similarity between the closed-pore change rate and the change rate of tortuosity depending on the degree of rolling. Next, this will be described in more detail.

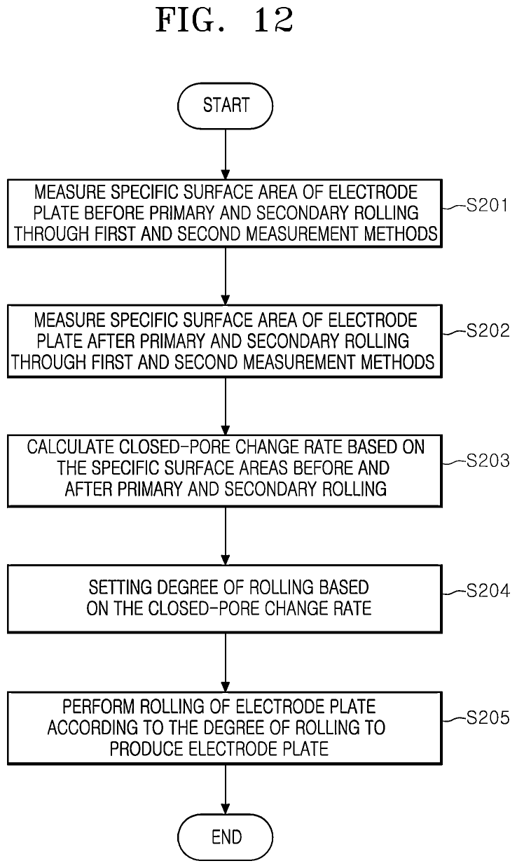

FIG. 12 is a flowchart illustrating an electrode manufacturing method according to some embodiments of the present invention;

FIG. 12 shows a method of measuring the closed-pore change rate of the electrode plate 200 and determining an optimal rolling degree for manufacturing the electrode plate 200 based on the closed-pore change rate measured using the method of measuring the closed-pore change rate illustrated with respect to FIG. 5A to FIG. 9.

On the other hand, the manufacturing method illustrated with respect to FIG. 12 may be performed not only by the electrode manufacturing system 300 according to the embodiments illustrated with respect to FIG. 8, but also by any system including separate devices capable of performing corresponding operations, or by other devices capable of performing corresponding operations. In other words, an entity capable of implementing the electrode manufacturing method according to the embodiments illustrated with respect to FIG. 12 is not limited to the electrode manufacturing system 300 according to some embodiments. However, in FIG. 12 and the following description, the electrode manufacturing method according to some embodiments performed by the electrode manufacturing system 300 will be described by way of example for convenience of description.

Referring to FIG. 12, the electrode manufacturing method according to some embodiments includes the operation of measuring specific surface areas of the electrode plate 200 in first and second powder states through the first and second measurement methods (S201). The description of operation S201 is the same as or similar to the description of operation S101.

Referring to FIG. 12, the electrode manufacturing method according to some embodiments includes the operation of measuring specific surface areas of the electrode plate 200 in first and second electrode plate states through the first and second measurement methods (S202). The description of operation S202 is the same as or similar to the description of operation S102.

Referring to FIG. 12, the electrode manufacturing method according to some embodiments includes the operation of calculating a closed-pore change rate based on the specific surface areas in the first and second powder states and in the first and second electrode plate states (S203). The description of operation S203 is the same as or similar to the description of operation S103.

Referring to FIG. 12, the electrode manufacturing method according to some embodiments includes the operation of setting a degree of rolling based on the closed-pore change rate (S204).

The processor 350 sets the degree of rolling that allows the closed-pore change rate to be within a range (e.g., a set or predetermined range). The degree of rolling includes, for example, at least one of rolling strength, rolling speed, or rolling time. In the following description, the degree of rolling is described using rolling strength by way of example for convenience of description. However, it should be understood that the range (e.g., the set or predetermined range) of the closed-pore change rate may also be set using other parameters.

For example, as shown in FIG. 11, the processor 350 determines tortuosity of the electrode plate 200 according to the degree of rolling. The processor 350 determines a zone in which the tortuosity of the electrode plate 200 changes rapidly (for example, increases). Alternatively, for example, as shown in FIG. 11, the processor 350 determines the closed-pore change rate according to the degree of rolling. The processor 350 determines a zone in which the closed-pore change rate changes rapidly (for example, increases). Based on the relationship between the tortuosity and the closed-pore change rate according to the degree of rolling, the processor 350 determines the zone in which the tortuosity increases rapidly and the zone in which the closed-pore change rate changes rapidly. From this process, the processor 350 may determine the zone in which the tortuosity of the electrode plate increases rapidly (indicating, for example, the degree of overpressure) based on the closed-pore change rate.

Thus, for example, the processor 350 sets the zone in which the closed-pore change rate changes rapidly as a range (e.g., a set or predetermined range). The processor 350 sets the degree of rolling that allows the closed-pore change rate to be within the range (e.g., the set or predetermined range).

Referring to FIG. 12, the electrode manufacturing method according to some embodiments includes the operation of manufacturing an electrode plate by rolling the electrode plate 200 according to the set degree of rolling (S205).

The processor 350 allows rolling of powder to the degree of rolling set in operation S204. As a result, the electrode plate 200 is subjected to a suitable degree of rolling.

In this way, the electrode manufacturing method according to some embodiments can manufacture an electrode plate by rolling the electrode plate 200 to an optimal degree of rolling. Further, the electrode manufacturing method according to some embodiments may provide a method of manufacturing an electrode and/or a secondary battery including an electrode plate having a high energy density and excellent mobility of lithium ions.

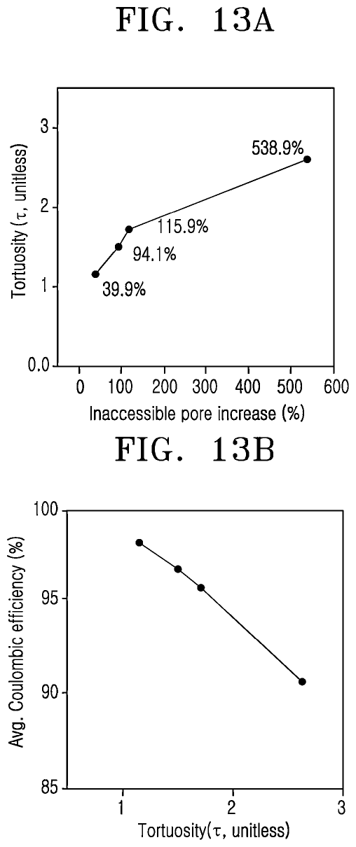

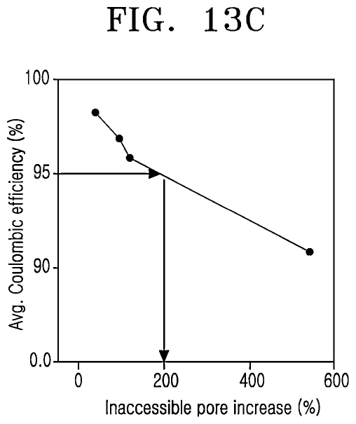

FIG. 13A to FIG. 13C are a graph depicting a relationship between the degree of rolling and performance of an electrode plate.

As illustrated in FIG. 11 and FIG. 12, in some embodiments, the rolling strength is set to allow the closed-pore change rate to be within a range (e.g., a set or predetermined range). Referring to FIG. 13A to FIG. 13C, the range (e.g., the set or predetermined range) of the closed-pore change rate will be described by way of example.

FIG. 13A is a graph depicting tortuosity of the electrode plate 200 according to the closed-pore change rate. FIG. 13B is a graph depicting Coulombic efficiency according to tortuosity of the electrode plate 200. From FIG. 13A and FIG. 13B, it can be seen that, at a certain degree of rolling (for example, in a zone where the thickness of the rolled electrode plate is changed from 80 μm to 70 μm), the closed-pore change rate increases rapidly from 100% to 538% and the tortuosity increases rapidly from a mid-1 value (for example, 1.146, 1.494, 1.707) to 2.612. Here, as described above, the tortuosity is linearly correlated with efficiency of coin cell evaluation.

FIG. 13C is a graph depicting Coulombic efficiency according to the closed-pore change rate.

The processor 350 determines, for example, based on the results shown in FIG. 13A to FIG. 13B, a zone where the Coulombic efficiency is greater than or equal to a value (e.g., a set or predetermined value). The value (e.g., the set or predetermined value) is, for example, 95%.

However, the value (e.g., the set or predetermined value) is not limited to 95% and may vary depending on the electrode plate 200 or materials included in the electrode plate 200. The value (e.g., the set or predetermined value) is the highest coulombic efficiency that the electrode plate 200 can have upon suitable rolling of the electrode plate 200 in a suitable rolling state and an overpressure state. Here, the suitable rolling state and the overpressure state may be divided by the zone in which the tortuosity rapidly increases, for example, as depicted in the graph in FIG. 13C.

The processor 350 determines that efficiency of the electrode plate 200 decreases at an increased closed-pore change rate corresponding to a value (e.g., a set or predetermined value). For example, referring to FIG. 13C, the processor 350 determines that tortuosity of the electrode plate 200 increases rapidly and efficiency of the electrode plate 200 decreases in a zone where the increased closed-pore change rate is greater than or equal to about 200%.

Accordingly, the processor 350 may, for example, set the range (e.g., the set or predetermined range) in operation S204 of FIG. 12 to “200% or less.” In this case, for example, the processor 350 sets the rolling strength such that the closed-pore change rate becomes 200% or less.

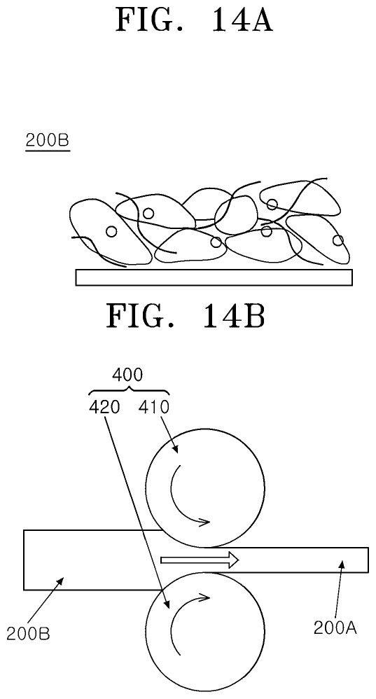

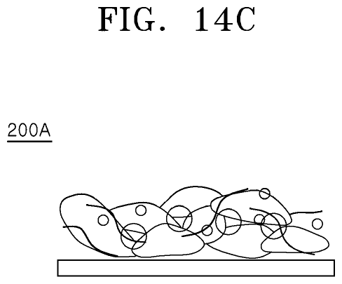

FIG. 14A to FIG. 14C are a schematic view of an electrode plate according to some embodiments of the present invention before and after rolling.

Referring to FIG. 14A to FIG. 14C, the electrode plate 200 manufactured by the manufacturing method illustrated in FIG. 5A to FIG. 13C will be now described.

FIG. 14A shows a state of powder 200B.

Referring to FIG. 14B, the powder 200B is rolled at a degree of rolling (e.g., a set or predetermined degree of rolling) by a rolling roller 400 including, for example, an upper roller 410 and/or a lower roller 420. Here, the degree of rolling (e.g., the set or predetermined degree of rolling) is a degree of rolling set according to the method calculated or illustrated in FIG. 5A to FIG. 13C. The degree of rolling may be controlled, for example, depending on a distance between the upper roller 410 and the lower roller 420 and/or a rotational speed of the rolling roller 400.

FIG. 14C shows an electrode plate state 200A rolled to a suitable degree of rolling.

Here, the closed-pore change rate between the electrode plate state 200A and the powder state 200B is in the range (e.g., the set or predetermined range) described in S204 of FIG. 12. For example, in an electrode plate including an anode material and a substrate coated with the anode material, the closed-pore change rate in the anode material before and after rolling is 200% or less.

As such, the electrode plate according to some embodiments is rolled to satisfy a closed-pore change rate within a range (e.g., a set or predetermined range). As a result, embodiments of the present invention can provide a highly efficient electrode plate, an electrode including the electrode plate, and/or a secondary battery including the electrode plate.

The embodiments of the present invention suggest use of two or more different mechanisms to measure pores and open pores of the electrode plate 200 in the powder state and in the electrode plate state and to calculate the closed-pore change rate through cross analysis thereof. However, application of the embodiments of the present invention is not limited thereto. For example, the embodiments of the present invention are applicable to any physical and/or chemical processes other than rolling so long as the change rate of pores can be measured thereby.

The electronic or electric devices and/or any other relevant devices or components according to some embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Although aspects of some embodiments of the present invention have been described with reference to some embodiments and drawings illustrating aspects thereof, embodiments according to the present invention are not limited thereto. Various modifications and variations can be made by a person skilled in the art to which the present invention belongs within the scope of the technical spirit of the invention and the claims and equivalents thereto.

What is claimed is:

1. A method of measuring a closed-pore change rate, the method comprising:
measuring, by small-angle X-ray scattering (SAXS) and Brunauer, Emmett, and Teller (BET), a specific surface area in a first powder state and a specific surface area in a second powder state with respect to pores created in a powder state;
measuring, by SAXS and BET, a specific surface area in a first electrode plate state and a specific surface area in a second electrode plate state with respect to pores created in an electrode plate state; and
calculating a closed-pore change rate of an electrode plate based on the specific surface areas in the first and second powder states and the specific surface areas in the first and second electrode plate states.

2. The method as claimed in claim 1, wherein, the closed-pore change rate is calculated according to Equation 1:
$$Closed - pore change rate ( \% ) = ( A - B ) \times 100 , \qquad ( 1 )$$
where A denotes an amount of change of the pores between the powder state and the electrode plate state, and B denotes an amount of change of open pores between the powder state and the electrode plate state.

3. The method as claimed in claim 2, wherein the amount of change of the pores between the powder state and the electrode plate state is calculated according to Equation 2:
$$A = \frac{EA - PA}{PA} , \qquad ( 2 )$$
where EA denotes a specific surface area of the pores in the first electrode plate state, as measured through SAXS, and PA denotes a specific surface area of the pores in the first powder state, as measured through SAXS.

4. The method as claimed in claim 2, wherein the amount of change of the open pores between the powder state and the electrode plate state is calculated according to Equation 3:
$$B = \frac{EB - PB}{PB} , \qquad ( 3 )$$
where EB denotes a specific surface area of the open pores in the second electrode plate state, as measured through BET, and PB denotes a specific surface area of the open pores in the second powder state, as measured through BET.

5. An electrode manufacturing method comprising:
measuring, by small-angle X-ray scattering (SAXS) and Brunauer, Emmett, and Teller (BET), a specific surface area in a first powder state and a specific surface area in a second powder state with respect to pores created in a powder state;
measuring, by SAXS and BET, a specific surface area in a first electrode plate state and a specific surface area in a second electrode plate state with respect to pores created in an electrode plate state;
calculating a closed-pore change rate of an electrode plate between the powder state and the electrode plate state based on the specific surface areas in the first and second powder states and the specific surface areas in the first and second electrode plate states;
setting a degree of rolling for the electrode plate based on the closed-pore change rate of the electrode plate; and
manufacturing the electrode plate by rolling the electrode plate according to the degree of rolling.

6. The electrode manufacturing method as claimed in claim 5, wherein the closed-pore change rate is calculated according to Equation 1:
$$Closed - pore change rate ( \% ) = ( A - B ) \times 100 , \qquad ( 1 )$$
where A denotes an amount of change of the pores between the powder state and the electrode plate state, and B denotes an amount of change of open pores between the powder state and the electrode plate state.

7. The electrode manufacturing method as claimed in claim 6, wherein the amount of change of the pores between the powder state and the electrode plate state is calculated according to Equation 2:
$$A = \frac{EA - PA}{PA} , \qquad ( 2 )$$
where EA denotes a specific surface area of the pores in the first electrode plate state, as measured through SAXS, and PA denotes a specific surface area of the pores in the first powder state, as measured through SAXS.

8. The electrode manufacturing method as claimed in claim 6, wherein the amount of change of the open pores between the powder state and the electrode plate state is calculated according to Equation 3:
$$B = \frac{EB - PB}{PB} , \qquad ( 3 )$$
where EB denotes a specific surface area of the open pores in the second electrode plate state, as measured through BET, and PB denotes a specific surface area of the open pores in the second powder state, as measured through BET.

9. The electrode manufacturing method as claimed in claim 5, wherein setting the degree of rolling comprises setting rolling strength such that the closed-pore change rate is in a predetermined range.

10. The electrode manufacturing method as claimed in claim 9, wherein the predetermined range is 200% or less.

11. An electrode manufacturing system comprising:
a measurement unit measuring specific surface areas in a powder state and in an electrode plate state through SAXS (Small-Angle X-ray Scattering) and BET (Brunauer, Emmett, Teller); and
a processor calculating a closed-pore change rate of an electrode plate based on specific surface areas in first and second powder states and specific surface areas in first and second electrode plate states measured by the measurement unit, and setting a degree of rolling for the electrode plate based on the closed-pore change rate of the electrode plate.

12. The electrode manufacturing system as claimed in claim 11, wherein the processor calculates the closed-pore change rate according to Equation 1:
$$Closed - pore change rate ( \% ) = ( A - B ) \times 100 , \qquad ( 1 )$$
where A denotes an amount of change of pores between the powder state and the electrode plate state, and B denotes an amount of change of open pores between the powder state and the electrode plate state.

13. The electrode manufacturing system as claimed in claim 12, wherein the processor calculates the amount of change of the pores between the powder state and the electrode plate state according to Equation 2:
$$A = \frac{EA - PA}{PA} , \qquad ( 2 )$$
where EA denotes a specific surface area of the pores in the first electrode plate state, as measured through SAXS, and PA denotes a specific surface area of the pores in the first powder state, as measured through SAXS.

14. The electrode manufacturing system as claimed in claim 12, wherein the processor calculates the amount of change of the open pores between the powder state and the electrode plate state according to Equation 3:
$$B = \frac{EB - PB}{PB} , \qquad ( 3 )$$
where EB denotes a specific surface area of the open pores in the second electrode plate state, as measured through BET, and PB denotes a specific surface area of the open pores in the second powder state, as measured through BET.

15. The electrode manufacturing system as claimed in claim 11, wherein the processor sets rolling strength such that the closed-pore change rate is less than or equal to 200%.

16. An electrode comprising:
an anode material; and
a substrate coated with the anode material,
wherein the anode material has a closed pore change rate of 200% or less before and after rolling.
